(19) United States
(12) Patent Application Publication
(10) Pub. No.: US 2016/0369072 A1
(43) Pub. Date: Dec. 22, 2016

(54) WATER-SOLUBLE FILM FOR PACKAGING CHEMICALS AND WATER-SOLUBLE FILM PACKAGE

(71) Applicant: SEKISUI SPECIALTY CHEMICALS AMERICA, LLC, Dallas, TX (US)

(72) Inventor: Hidehiro YAMAGUCHI, Dallas, TX (US)

(21) Appl. No.: 14/740,318

(22) Filed: Jun. 16, 2015

(51) Int. Cl. C08J 5/18; C08K 5/06; C08K 5/053; C08F 116/06; C08K 5/00

(52) U.S. Cl. CPC C08J 5/18; C08F 116/06; C08K 5/0016; C08K 5/053; C08K 5/06; C08J 2329/04

(57) ABSTRACT

The present invention provides a water-soluble film for packaging chemicals which achieves excellent chemical resistance and water solubility and maintains high packaging properties even in a case of containing highly active chemicals such as agrochemicals or oxidants for a long period of time, and a water-soluble film package including the water-soluble film for packaging chemicals. The present invention relates to a water-soluble film for packaging chemicals, including polyvinyl alcohol, the polyvinyl alcohol containing a modified polyvinyl alcohol, the water-soluble film for packaging chemicals having a water content of 4 to 13 parts by mass based on 100 parts by mass of the polyvinyl alcohol, the water-soluble film for packaging chemicals having an orientation of 10 to 150 nm.

### TECHNICAL FIELD

The present invention relates to a water-soluble film for packaging chemicals which achieves excellent chemical resistance and water solubility and maintains high packaging properties even in a case of containing highly active chemicals such as agrochemicals or oxidants for a long period of time, and also relates to a water-soluble film package including the water-soluble film for packaging chemicals.

### BACKGROUND ART

Polyvinyl alcohol (hereinafter, also referred to as PVA), which is excellent in transparency, oil resistance, chemical resistance, and gas (e.g. oxygen) barrier properties, has been widely used as a packaging material. In recent years, PVA has been often used as a packaging material for foods, drugs, industrial chemicals, agrochemicals, or the like whose characteristics are largely affected by oxidation degradation.

When a film of PVA is used for packaging chemicals or the like, for example, a chemical is filled in a PVA film that is continuously delivered, and the film containing the chemical is made into a pouch. Because of its excellent solubility in water especially at normal temperature, a PVA film has been widely used for a package for containing a household detergent or an agrochemical that may be dangerous if touched with bare hands.

When a highly active chemical is packaged in a PVA film, however, an alkaline material, an auxiliary agent (e.g., activators, dispersants, anti-soil redeposition agents), or the like contained in a detergent gradually reacts with the PVA film to allow a reaction of crosslinking or saponification to proceed, problematically resulting in insolubilization of the water-soluble film.

To solve such a problem, Patent Literature 1 discloses a film for packaging alkaline materials which is composed of a polyvinyl alcohol-based resin having a 1,2-glycol bond content of 1.8 mol % or more and a degree of saponification of 92 to 99.9 mol %.

Such a film for packaging alkaline materials is highly resistant against alkaline materials but is not sufficiently resistant against acidic materials such as agrochemicals and disinfectants for pools. As a result, the film problematically has reduction in the solubility or discoloration during storage for a long period of time.

Patent Literature 2 discloses a water-soluble film in which polyvinyl alcohol and 1 to 8 mol % of 2-acrylamido-2-methylpropane sulfonic acid in free acid form or the free acid (AMPS) as a salt are copolymerized to improve the chemical resistance against agrochemicals or chemicals for pools.

Such a water-soluble film however has insufficient chemical resistance against strong oxidants such as trichloroisocyanuric acid. Moreover, the obtained film loses its flexibility during storage for a long period of time to be easily torn, leading to leakage of a chemical contained therein.

### CITATION LIST

### Patent Literature

Patent Literature 1: JP-A 2001-206960
Patent Literature 2: JP-A 2012-229430

### SUMMARY OF INVENTION

### Technical Problem

The present invention aims to provide a water-soluble film for packaging chemicals which achieves excellent chemical resistance and water solubility and maintains high packaging properties even in a case of containing highly active chemicals such as agrochemicals or oxidants for a long period of time, and also relates to a water-soluble film package including the water-soluble film for packaging chemicals.

### Solution to Problem

The present invention relates to a water-soluble film for packaging chemicals, including polyvinyl alcohol, the polyvinyl alcohol containing a modified polyvinyl alcohol, the water-soluble film for packaging chemicals having a water content of 4 to 13 parts by mass based on 100 parts by mass of the polyvinyl alcohol, the water-soluble film for packaging chemicals having an orientation of 10 to 150 nm.

The present invention is specifically described in the following.

The present inventors found out that, when polyvinyl alcohol containing a modified polyvinyl alcohol is used as a component of a water-soluble film for packaging chemicals and the orientation and the water content of the water-soluble film for packaging chemicals are set within predetermined ranges, the resulting water-soluble film achieves excellent chemical resistance and water solubility and maintains high packaging properties even in a case of containing highly active chemicals such as agrochemicals or oxidant for a long period of time. In this manner, the present invention has been completed.

Each component of the water-soluble film for packaging chemicals of the present invention is specifically described in the following.

### (Polyvinyl Alcohol (PVA))

The water-soluble film for packaging chemicals of the present invention contains polyvinyl alcohol. The polyvinyl alcohol is a main constitutional component of the water-soluble film for packaging chemicals of the present invention.

In the present invention, the PVA contains a modified polyvinyl alcohol (modified PVA). The term “polyvinyl alcohol (PVA)” herein refers to polyvinyl alcohol as a whole, not one of modified PVA and unmodified PVA.

The polyvinyl alcohol is prepared in such a way that a vinyl ester is polymerized to give a polymer, and the polymer is saponified, that is, hydrolyzed, in accordance with a conventionally known method. An alkali or an acid is generally used in saponification. An alkali is preferably used. As the polyvinyl alcohol, only one kind of polyvinyl alcohol may be used, or two or more kinds of polyvinyl alcohols may be used in combination.

Examples of the vinyl ester include vinyl acetate, vinyl formate, vinyl propionate, vinyl butyrate, vinyl pivalate, vinyl versatate, vinyl laurate, vinyl stearate, and vinyl benzoate.

The vinyl ester may be polymerized by any method. Examples of the method include solution polymerization, bulk polymerization, and suspension polymerization.

A polymerization catalyst may be used in polymerization of the vinyl ester, and examples of the polymerization catalyst include 2-ethylhexyl peroxydicarbonate (produced by Tianjin McEIT, “TrigonoxEHP”), 2,2′-azobisisobutyronitrile (AIBN), t-butyl peroxyneodecanoate, bis(4-t-butylcyclohexyl) peroxydicarbonate, di-n-propyl peroxydicarbonate, di-n-butyl peroxydicarbonate, di-cetyl peroxydicarbonate, and di-s-butyl peroxydicarbonate. Each of these polymerization catalysts may be used alone, or two or more of these may be used in combination.

The polymer of the vinyl ester is preferably a polyvinyl ester because the degree of saponification is easily controlled to a favorable range. Further, the polymer of the vinyl ester may be a copolymer of the vinyl ester and other monomers. That is, the polyvinyl alcohol may be formed from a copolymer of the vinyl ester and other monomers. Examples of the other monomers, that is, comonomers for copolymerization, include olefins, (meth)acrylic acid and salts thereof, (meth)acrylic acid esters, (meth)acrylamide derivatives, N-vinyl amides, vinyl ethers, nitriles, vinyl halides, allyl compounds, maleic acid and salts thereof, maleic acid esters, itaconic acid and salts thereof, itaconic acid esters, vinyl silyl compounds, and isopropenyl acetate. Each of the other monomers may be used alone, or two or more of these may be used in combination.

Examples of the olefins include ethylene, propylene, 1-butene, and isobutene. Examples of the (meth)acrylic acid esters include methyl (meth)acrylate, ethyl (meth)acrylate, n-propyl (meth)acrylate, i-propyl (meth)acrylate, n-butyl (meth)acrylate, and 2-ethylhexyl (meth)acrylate. Examples of the (meth)acrylamide derivatives include acrylamide, n-methyl acrylamide, N-ethyl acrylamide, N,N-dimethyl acrylamide, and (meth)acrylamide propane sulfonic acid and salts thereof. Examples of the N-vinyl amides include N-vinylpyrrolidone. Examples of the vinyl ethers include methyl vinyl ether, ethyl vinyl ether, n-propyl vinyl ether, i-propyl vinyl ether, and n-butyl vinyl ether. Examples of the nitriles include (meth)acrylonitrile. Examples of the vinyl halides include vinyl chloride and vinylidene chloride. Examples of the allyl compounds include allyl acetate and allyl chloride. Examples of the vinyl silyl compounds include vinyl trimethoxy silane.

The PVA has a degree of saponification of preferably 80.0 to 99.0 mol %.

When the degree of saponification is equal to or more than the lower limit, and equal to or less than the upper limit, the water resistance of the water-soluble film for packaging chemicals and the dissolution time for releasing chemicals can be easily controlled to improve both the water resistance and the dissolution time in a balanced manner.

The lower limit of the degree of saponification of the PVA is more preferably 88.0 mol %, and the upper limit thereof is more preferably 98.0 mol %.

The degree of saponification is measured in accordance with JIS K 6726. The degree of saponification represents the proportion of units actually saponified to vinyl alcohol units in units to be saponified to vinyl alcohol units.

The degree of saponification may be controlled by any method. The degree of saponification can be appropriately controlled depending on saponification conditions, that is, hydrolysis conditions.

The PVA preferably has a standard deviation (o) of distribution of the degree of saponification of 0.1 to 1.0 mol %.

When the standard deviation of distribution of the degree of saponification is equal to or more than the lower limit, and equal to or less than the upper limit, the solubility and the chemical resistance of the water-soluble film for packaging chemicals are enhanced to improve both the dissolution time for releasing chemicals and the storage period of the film packaging chemicals in a balanced manner.

More preferably, the lower limit of the standard deviation of the distribution of the degree of saponification is 0.2 mol %, and the upper limit thereof is 0.9 mol %.

The standard deviation of distribution of the degree of saponification is an indicator of variation of the degree of saponification in the PVA, and can be measured using FT-IR or the like.

The PVA may have any degree of polymerization. The lower limit of the degree of polymerization of the PVA is preferably 400, more preferably 500, still more preferably 600, and particularly preferably 900. The upper limit thereof is preferably 2000, more preferably 1800, and still more preferably 1500. When the degree of polymerization is equal to or more than the lower limit, and equal to or less than the upper limit, an aqueous solution with an appropriate viscosity for forming the water-soluble film for packaging chemicals can be obtained. When the degree of polymerization is equal to or less than the upper limit, the strength of the PVA film for packaging chemicals further increases to impart appropriate water resistance. The degree of polymerization is measured in accordance with JIS K 6726.

The lower limit of the viscosity of a 4% by mass aqueous solution of the PVA measured at 20° C. is preferably 4 mPa·s, and the upper limit thereof is preferably 17 mPa·s. The viscosity set to be 4 mPa·s or higher can improve the water resistance. The viscosity set to be 17 mPa·s or lower can shorten the dissolution time. More preferably, the lower limit of the viscosity is 8 mPa·s, and the upper limit thereof is 15 mPa·s.

The viscosity can be measured in accordance with JIS K 6726.

The PVA contains a modified PVA.

The modified PVA is preferably one modified with at least one hydrophilic group selected from the group consisting of a sulfonic acid group, a pyrrolidone ring, an amino group, and a carboxyl group.

In particular, a sulfonic acid group and a pyrrolidone ring are preferred. The hydrophilic group may include sodium salts, potassium salts, and any other salts, of the functional groups described above.

The modified PVA modified with the hydrophilic group includes one obtainable by copolymerizing an unmodified polyvinyl alcohol with a monomer containing the hydrophilic group, and one obtainable by adding the hydrophilic group to an unmodified polyvinyl alcohol.

Examples of the modified PVA include a sulfonic acid group-modified polyvinyl alcohol, a pyrrolidone ring-modified polyvinyl alcohol, an amino group-modified polyvinyl alcohol, a carboxyl group-modified polyvinyl alcohol, and an amide group-modified polyvinyl alcohol.

The sulfonic acid group-modified polyvinyl alcohol may be any polyvinyl alcohol to which a sulfonic acid group is introduced by modification, and preferably has a sulfonic acid group bonded to a polymer main chain through a linking group.

Examples of the linking group include an amide group, an alkylene group, an ester group, and an ether group. In particular, a combination of an amide group and an alkylene group is preferred.

The sulfonic acid group preferably includes a sulfonate, and is particularly preferably a sodium sulfonate group.

In particular, in cases where the modified PVA is a sodium sulfonate-modified polyvinyl alcohol, the sodium sulfonate-modified polyvinyl alcohol preferably has a constitutional unit represented by the formula (1).

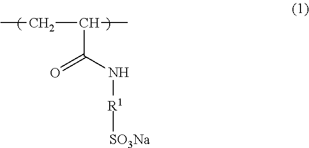

In the formula (1), R¹ represents a C1-C4 linear or branched alkylene group.

In cases where the modified PVA is a pyrrolidone ring-modified polyvinyl alcohol, the pyrrolidone ring-modified polyvinyl alcohol preferably has a constitutional unit represented by the formula (2).

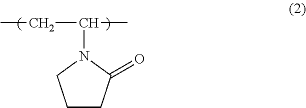

In cases where the modified PVA is an amino group-modified polyvinyl alcohol, the amino group-modified polyvinyl alcohol preferably has a constitutional unit represented by the formula (3).

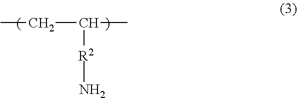

In the formula (3), R² represents a single bond or a C1-C10 alkylene group.

In cases where the modified PVA is a carboxyl group-modified polyvinyl alcohol, the carboxyl group-modified polyvinyl alcohol preferably has a constitutional unit represented by the formula (4-1), (4-2), or (4-3).

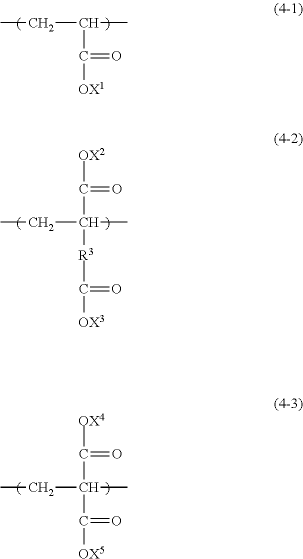

In the formulae (4-1), (4-2), and (4-3), X¹, X², X³, X⁴, and X⁵ each independently represent a hydrogen atom, a metal atom, or a methyl group. That is, a carboxyl group in a carboxyl group-containing constitutional unit herein includes a salt of a carboxyl group and a methyl ester of a carboxyl group. Examples of the metal atom include a sodium atom.

In the formula (4-2), R³ represents a C1-C10 alkylene group.

Examples of the amide group-modified polyvinyl alcohol include those having a constitutional unit derived from a monomer that has a vinyl group and an amide group such as N-vinyl formamide and N-vinyl acetamide.

The modified PVA is commercially available as, for example, “KL-318”, “KL-118”, “KM-618”, or “KM-118” (all produced by KURARAY CO., LTD.).

The amount of the constitutional unit having a hydrophilic group in the modified PVA is preferably 0.1 to 15 mol %. When the amount of the constitutional unit having a hydrophilic group is equal to or more than the lower limit, and equal to or less than the upper limit, a film resistant to chlorine-containing hygiene agents or oxidizing chemicals over a long period of time and free of discoloration or breakage can be obtained.

The lower limit of the amount of the constitutional unit having a hydrophilic group is more preferably 2.5 mol %, and the upper limit thereof is more preferably 12 mol %.

The modified PVA is prepared, for example, by saponifying a modified polyvinyl acetate that is obtained by copolymerization, copolymerizing an unmodified polyvinyl alcohol with a hydrophilic group-containing monomer, or adding a hydrophilic group to an unmodified polyvinyl alcohol.

The lower limit of the amount of the modified polyvinyl alcohol in the entire polyvinyl alcohol is preferably 50 to 100% by mass.

When the amount of the modified polyvinyl alcohol is set within the above range, a film obtained is less likely to be discolored or broken for a long period of time and exhibits excellent solubility when dissolved in water.

The lower limit of the amount of the modified polyvinyl alcohol in the entire polyvinyl alcohol is more preferably 60% by mass.

The lower limit of the amount of the polyvinyl alcohol is preferably 70% by mass, and the upper limit thereof is preferably 97% by mass, in 100% by mass of the water-soluble film for packaging chemicals of the present invention.

When the amount of the polyvinyl alcohol is equal to or more than the lower limit, a higher-quality water-soluble film for packaging chemicals in which no bleeding of a plasticizer occurs can be obtained. When the amount of the polyvinyl alcohol is equal to or less than the upper limit, a PVA film for packaging chemicals with higher strength and appropriate water resistance can be obtained.

### (Plasticizer)

The water-soluble film for packaging chemicals of the present invention preferably further contains a plasticizer.

Water-soluble films for packaging chemicals, which are transported, stored, or used even in a high-temperature and high-humidity area or a cold area, need to have high tensile strength or durability. In particular, impact resistance at low temperature is considered to be important. The water-soluble film for packaging chemicals of the present invention containing a plasticizer can have a lower glass-transition temperature, and improved durability at low temperature. Further, the water-soluble film for packaging chemicals can have higher water solubility when it contains the plasticizer.

The plasticizer may be any plasticizer commonly used for PVA, and examples thereof include polyhydric alcohols such as glycerin, diglycerin, diethylene glycol, trimethylolpropane, triethylene glycol, dipropylene glycol, or propylene glycol; polyethers such as polyethylene glycol or polypropylene glycol; phenol derivatives such as bisphenol A or bisphenol S; amide compounds such as N-methylpyrrolidone; compounds prepared by adding an ethylene oxide to a polyhydric alcohol such as glycerin, pentaerythritol, or sorbitol; and water. Each of these may be used alone, or two or more of these may be used in combination.

Among the plasticizers, glycerin, trimethylolpropane, polyethylene glycol, polypropylene glycol, triethylene glycol, dipropylene glycol, and propylene glycol are preferred because they can improve water solubility. In particular, glycerin and trimethylolpropane are preferred because they further improve water solubility.

In the water-soluble film for packaging chemicals of the present invention, the lower limit of the amount of the plasticizer is preferably 1 part by mass, and the upper limit thereof is preferably 12 parts by mass, based on 100 parts by mass of the polyvinyl alcohol.

When the amount of the plasticizer is set to 1 part by mass or more, effects obtained by addition of the plasticizer can be fully exhibited. When the amount of the plasticizer is set to 12 parts by mass or less, bleeding of the plasticizer can be prevented, thereby improving the antiblocking properties of an obtained water-soluble film for packaging chemicals.

The lower limit of the amount of the plasticizer is more preferably 5 parts by mass, and the upper limit thereof is more preferably 10 parts by mass.

The water-soluble film for packaging chemicals of the present invention contains water, and the water content is 4 to 13 parts by mass based on 100 parts by mass of the polyvinyl alcohol.

When the water content is 4 parts by mass or more, the glass transition temperature of the polyvinyl alcohol is lowered, which enables production of a strong water-soluble film for packaging chemicals and a package each having flexibility and strength. When the water content is 13 parts by mass or less, bleeding of the plasticizer or additives is prevented, which enables production of a uniform water-soluble film for packaging chemicals, and an excessive reaction between the contents and an oxidant is suppressed, which can enhance the durability of the chemical resistance. The lower limit is preferably 4.5 parts by mass, and the upper limit is preferably 10 parts by mass.

The water content can be determined, for example, by measuring the reduction amount of water after drying with an infrared moisture meter.

The water-soluble film for packaging chemicals of the present invention has an orientation of 10 to 150 nm.

When the orientation is equal to or more than the lower limit, and equal to or less than the upper limit, the solubility and chemical resistance of the water-soluble film for packaging chemicals can be enhanced to improve both the dissolution time for releasing chemicals and the storage period of the film packaging chemicals in a balanced manner.

The lower limit of the orientation is preferably 15 nm, and the upper limit is preferably 120 nm.

The orientation is an indicator of the regularity of the PVA molecular arrangement in the water-soluble film for packaging chemicals, and can be measured with a phase difference measuring apparatus (KOBRA-WR, produced by Oji Scientific Instruments).

The upper limit of the thickness of the water-soluble film for packaging chemicals of the present invention is preferably 100 μm, more preferably 80 μm, and still more preferably 75 μm. The lower limit of the thickness of the film for packaging chemicals of the present invention is preferably 10 μm. When the thickness of the water-soluble film for packaging chemicals is equal to or more than the lower limit, the strength of the film for packaging chemicals is further increased. When the thickness of the water-soluble film for packaging chemicals is equal to or less than the upper limit, packaging performance or heat sealing performance of the water-soluble film for packaging chemicals is further enhanced to reduce the processing time, leading to higher productivity.

The water-soluble film for packaging chemicals of the present invention may appropriately contain, if necessary, conventional additives such as colorants, flavor ingredients, bulking agents, defoaming agents, removers, ultraviolet absorbers, or surfactants. Especially for the purpose of improving the releasability of a formed film or a film liquid from a metal surface of a die or a drum of a film forming machine, a surfactant is preferably added in an amount of 0.01 to 5 parts by mass based on 100 parts by mass of PVA.

The lower limit of the contact angle of the water-soluble film for packaging chemicals of the present invention measured by a drop method using distilled water is preferably 20°, and the upper limit thereof is preferably 50°. When the contact angle is 20° or more, a water-soluble film for packaging chemicals with excellent delivery performance can be obtained. When the contact angle is 50° or less, a water-soluble film for packaging chemicals suppressing contamination of the roll can be obtained. The lower limit of the contact angle is more preferably 23°, and still more preferably 30°. The upper limit thereof is more preferably 49°, and still more preferably 40°.

The contact angle can be measured in accordance with JIS R 3257. For example, the contact angle can be measured using a contact angle measurement apparatus “Theta light” (produced by Biolin Scientific) by dropping distilled water on the water-soluble film for packaging chemicals.

### (Method for Producing Water-Soluble Film for Packaging Chemicals)

The water-soluble film for packaging chemicals of the present invention may be produced by any method, and may be produced by a method in which a PVA aqueous solution containing PVA that contains a modified PVA, water, and if necessary a plasticizer is cast on a supporting member, and dried. Specifically, a solution casting method, a roll coating method, a spin coating method, a screen coating method, a fountain coating method, a dipping method, or a spraying method may be mentioned.

The PVA aqueous solution contains water and if necessary a plasticizer in addition to the PVA. The PVA is mainly dissolved in the water.

In the PVA aqueous solution, the amount of the water is 300 parts by mass or more, preferably 400 parts by mass or more, and more preferably 500 parts by mass or more based on 100 parts by mass of components including the PVA, other than water.

The amount of the water is 900 parts by mass or less, preferably 800 parts by mass or less, and more preferably 700 parts by mass or less. When the amount of the water is equal to or more than the lower limit, the viscosity of the PVA aqueous solution is appropriately reduced, which enables easy casting of the PVA aqueous solution. When the amount of the water is equal to or less than the upper limit, the viscosity of the PVA aqueous solution is appropriately increased, which enables easy casting of the PVA aqueous solution. Moreover, the drying time can be further reduced, and the orientation of the PVA film can further be enhanced. In other words, a higher-quality film for packaging chemicals can be obtained.

The supporting member is preferably capable of allowing a PVA aqueous solution to remain on the surface upon casting the PVA aqueous solution, and is preferably capable of supporting the obtained PVA film. Examples of a material of the supporting member include polyolefins, polyesters, and acrylic resins. The supporting member may be formed from another material. Examples of the polyolefins include ethylene, polypropylene, ethylene-vinyl acetate copolymers, and ethylene-vinyl alcohol copolymers. Examples of the polyesters include polyethylene terephthalate and polyethylene naphthalate. Use of PVA as the material of the supporting member is not preferred.

The PVA aqueous solution cast on the supporting member may be dried by any appropriate method. The solution may be dried naturally, or by heating at a temperature not higher than the glass transition temperature of the modified PVA.

In production of the water-soluble film for packaging chemicals of the present invention, the amount of water can be adjusted, for example, by controlling the storage conditions after the film is released from the supporting member.

For example, the storage temperature is preferably 20 to 80° C. The storage humidity is preferably 20 to 70% RH. The storage time is preferably 2 to 48 hours.

The storage conditions may be controlled by any method, and a moisturizer, humidifier, or thermo-hygrostat may be used for keeping the humidity stable.

In production of the water-soluble film for packaging chemicals of the present invention, a stretching step is preferably performed during or after drying. Such a stretching step can more favorably set the orientation of the film for packaging chemicals within a predetermined range.

The stretching step is performed by, for example, stretching using a roller, a tenter, or a winder; stretching by drying shrinkage; or stretching by combination of these.

In the stretching step, the stretching ratio is preferably 1.05 to 3 times. The stretching ratio is more preferably 1.1 to 2.8 times.

The water-soluble film for packaging chemicals of the present invention is used for packaging a chemical to give a water-soluble film package. Such a water-soluble film package including the water-soluble film for packaging chemicals of the present invention and a chemical contained in the water-soluble film are also encompassed by the present invention.

The chemical is not particularly limited, and may be a chemical dissolved or dispersed in water. The chemical may be alkaline, neutral, or acidic, and has any shape such as granules, tablets, powder, particles, or liquid.

Specific examples thereof include agrochemicals, oxidants, detergents, auxiliaries of detergents, disinfectants, bleaching agents, dyes, and various pasting agents.

Especially when the chemical used is a compound containing chlorine or bromine, the effect of the present invention can be sufficiently exerted.

Examples of the compound containing chlorine include trichloroisocyanuric acid, dichloroisocyanuric acid, monochloroisocyanuric acid, dichloroisocyanic acid, N,N-dichlorohydantoin, and N-chloro-N-bromo-5,5-dimethylhydantoin. In particular, preferred are trichloroisocyanuric acid and dichloroisocyanuric acid.

Examples of the compound containing bromine include 2,2-dibromo-3-nitrilopropionamide, and 1-bromo-3-chloro-5,5-dimethylhydantoin.

Examples of the method for producing the water-soluble film package of the present invention include a method in which the water-soluble film for packaging chemicals is first made into a pouch shape and a chemical is contained therein, a method in which a chemical is first contained in the water-soluble film for packaging chemicals and the film containing the chemical is then made into a pouch, and a method in which a chemical is directly packaged in the water-soluble film for packaging chemicals.

### Advantageous Effects of Invention

The present invention can provide a water-soluble film for packaging chemicals which achieves excellent chemical resistance and water solubility and maintains high packaging properties even in a case of containing highly active chemicals such as agrochemicals or oxidants for a long period of time, and a water-soluble film package including the water-soluble film for packaging chemicals.

### DESCRIPTION OF EMBODIMENTS

In the following, the present invention will be described in more detail based on, but not limited to, examples.

### (Synthesis of Modified Polyvinyl Alcohol A)

A 10-L glass reactor carrying a silicone oil jacket was provided with a Teflon-coated stirring blade, a monomer-feeding pump, and a thermometer. The reactor was charged with vinyl acetate monomers (2000 g), N-vinyl pyrrolidone (121 g), and methanol (500 g), and deaerated with nitrogen gas sufficiently. Then, the temperature inside the reactor was raised to 60° C. 2,2′-Azobis(isobutyronitrile)(0.5 g) dissolved in methanol (100 mL) was added to the reactor over one hour, and the mixture was polymerized under heating for four hours. After completion of the reaction, the reaction product was cooled to 30° C. and taken out from the 10-L reactor.

The resulting methanol solution of a modified polyvinyl acetate was subjected to decompression treatment at 0.05 atm at 40° C. in a rotary evaporator, while methanol was added thereto. The treatment was repeated until a peak of residual vinyl acetate was not any more detected by gas chromatography, thereby removing residual monomer components. In this manner, a methanol solution (solid content concentration of 43% by mass) of a modified polyvinyl acetate was obtained.

The methanol solution of a modified polyvinyl acetate copolymer was blended with methanol to the concentration of 25% by mass. To the resulting solution, a methanol solution (10% by mass concentration) of NaOH having an alkali molar ratio (number of moles of NaOH/number of moles of vinyl acetate monomer (including modified component) unit) of 0.005 was added for saponification, so that a modified polyvinyl alcohol A (modified polyvinyl alcohol having a constitutional unit represented by the formula (2)) was obtained.

The obtained modified polyvinyl alcohol A had a degree of saponification of 90.5 mol %. The amount of a constitutional unit having N-vinyl pyrrolidone (amount of a modified group) was 4.2 mol %. A 4% by mass aqueous solution of the obtained modified polyvinyl alcohol A was prepared, and the viscosity thereof measured with a B-type viscometer (produced by BROOKFIELD ENGINEERING, LV-DV-II Pro) at 20° C. was 8.5 mPa·s.

### (Synthesis of Modified Polyvinyl Alcohol B)

A 10-L glass reactor carrying a silicone oil jacket was provided with a Teflon-coated stirring blade, a monomer-feeding pump, and a thermometer. The reactor was charged with vinyl acetate monomers (2000 g), a 50% by mass aqueous solution (560 g) of sodium 2-acrylamide-2-methylpropanesulfonate, and methanol (200 g), and deaerated with nitrogen gas sufficiently. Then, the temperature inside the reactor was raised to 60° C. 2,2′-Azobis(isobutyronitrile)(0.7 g) dissolved in methanol (100 mL) was added to the reactor over one hour, and the mixture was polymerized under heating for four hours. After completion of the reaction, the reaction product was cooled to 30° C. and taken out from the 10-L reactor.

The resulting methanol solution of a modified polyvinyl acetate was subjected to decompression treatment at 0.05 atm at 40° C. in a rotary evaporator, while methanol was added thereto. The treatment was repeated until a peak of residual vinyl acetate was not any more detected by gas chromatography, thereby removing residual monomer components. In this manner, a methanol solution (solid content concentration of 43% by mass) of a modified polyvinyl acetate was obtained.

The methanol solution of a modified polyvinyl acetate copolymer was blended with methanol to the concentration of 25% by mass. To the resulting solution, a methanol solution (10% by mass concentration) of NaOH having an alkali molar ratio (number of moles of NaOH/number of moles of vinyl acetate monomer (including modified component) unit) of 0.009 was added for saponification, so that a modified polyvinyl alcohol B (modified polyvinyl alcohol having a constitutional unit represented by the formula (1)) was obtained.

The obtained modified polyvinyl alcohol B had a degree of saponification of 94.5 mol %. The amount of a constitutional unit having sodium 2-acrylamide-2-methylpropanesulfonate (amount of a modified group) was 4.5 mol %. A 4% by mass aqueous solution of the obtained modified polyvinyl alcohol B was prepared, and the viscosity thereof measured at 20° C. was 17 mPa·s.

### (Synthesis of Modified Polyvinyl Alcohol C)

A 10-L glass reactor carrying a silicone oil jacket was provided with a Teflon-coated stirring blade, a monomer-feeding pump, and a thermometer. The reactor was charged with vinyl acetate monomers (2000 g), N-vinyl formamide (230 g), and methanol (400 g), and deaerated with nitrogen gas sufficiently. Then, the temperature inside the reactor was raised to 60° C. 2,2′-Azobis(isobutyronitrile)(0.5 g) dissolved in methanol (100 mL) was added to the reactor over one hour, and the mixture was polymerized under heating for four hours. After completion of the reaction, the reaction product was cooled to 30° C. and taken out from the 10-L reactor.

The resulting methanol solution of a modified polyvinyl acetate was subjected to decompression treatment at 0.05 atm at 40° C. in a rotary evaporator, while methanol was added thereto. The treatment was repeated until a peak of residual vinyl acetate was not any more detected by gas chromatography, thereby removing residual monomer components. In this manner, a methanol solution (solid content concentration of 50% by mass) of a modified polyvinyl acetate C was obtained. The methanol solution of a modified polyvinyl acetate copolymer was blended with methanol to the concentration of 25% by mass. To the resulting solution, a methanol solution (10% by mass concentration) of NaOH having an alkali molar ratio (number of moles of NaOH/number of moles of vinyl acetate monomer (including modified component) unit) of 0.03 was added for saponification.

The obtained modified polyvinyl alcohol was pulverized by a laboratory mill No 4 (produced by Thomus-Wiely), and the resulting powder was placed in a 5-L reactor. To the reactor, a 7% by mass methanol solution of sodium hydroxide (2000 g) was added. The mixture was stirred at 50° C. for three hours for hydrolysis of a formamide site. The reaction product was filtered and 100 g of powder was measured and taken out. The powder was subjected to Soxhlet extraction using a methanol solvent for 12 hours, so that excessive ion components were removed. The resulting powder was spread on a filter paper and dried in an exhaust oven at 80° C. for three hours to give a modified polyvinyl alcohol C (amino group-modified polyvinyl alcohol) powder. The obtained modified polyvinyl alcohol C had a degree of saponification of 99.9 mol %. The amount of a constitutional unit having N-vinyl formamide (amount of a modified group) was 9 mol %. A 4% by mass aqueous solution of the obtained modified polyvinyl alcohol C was prepared, and the viscosity thereof measured at 20° C. was 4 mPa·s.

### (Polyvinyl Alcohol D)

As polyvinyl alcohol D, a commercial product of a partially saponified polyvinyl alcohol (produced by Sekisui Specialty Chemicals America, Selvol205) was used. The polyvinyl alcohol D had a degree of saponification of 88.4 mol %. A 4% by mass aqueous solution of the polyvinyl alcohol D was prepared, and the viscosity thereof measured at 20° C. was 8 mPa·s.

TABLE 1

| | Degree of | Modified | Amount of | |
|---|---|---|---|---|
| | saponi- | group | modified | |
| | fication | (modified | groups | Viscosity |
| | (mol %) | monomer) | (mol %) | (mPa · s) |
| Modified polyvinyl | 90.5 | N-vinyl | 4.2 | 8.5 |
| alcohol A | | pyrrolidone | | |
| Modified polyvinyl | 94.5 | Sodium 2- | 4.5 | 17 |
| alcohol B | | acrylamide-2- | | |
| | | methylpro- | | |
| | | panesulfonate | | |
| Modified polyvinyl | 99.9 | N-vinyl | 9 | 4 |
| alcohol C | | formamide | | |
| Polyvinyl alcohol D | 88.4 | — | 0 | 8 |

### Example 1

### Production of Water-Soluble Film for Packaging Chemicals

A 500-mL metal beaker containing water (400 g) was charged with the modified polyvinyl alcohol A (100 g), trimethylolpropane (4 g), glycerin (4 g), and polyethylene glycol 500 (4 g) with stirring at 150 rpm. The mixture was stirred at 95° C. for two hours under heating to give a PVA aqueous solution having a solid content concentration of 22.3% by mass.

The obtained PVA aqueous solution was applied to a polyethylene terephthalate (PET) film (50 μm in thickness) serving as an supporting member, using an auto film applicator (produced by TESTER SANGYO CO., LTD., “PI-1210”), and dried at 80° C. for five minutes and then at 100° C. for 30 minutes. The resulting product was released from the supporting member, thereby obtaining a PVA film.

The obtained PVA film was left to stand still under the storage conditions as mentioned in Table 2, cut to a size of 150 mm×70 mm, and set on a tensile tester. The film was stretched at the stretching ratio as mentioned in Table 2 to give a water-soluble film for packaging chemicals. The stretching ratio is calculated by the following equation.

$$Stretching ratio ( \% ) = \frac{( Film length after stretching ) - ( Film length before stretching )}{Film length before stretching} \times 100$$

The water content (based on 100 parts by mass of polyvinyl alcohol) of the obtained water-soluble film for packaging chemicals measured by the following method was 8.4 parts by mass.

### [Measurement of Water Content]

The obtained water-soluble film for packaging chemicals (1.0 g) was set on an infrared moisture meter (produced by Kett Electric Laboratory, Infrared moisture detection balance FD-800), and heated at 80° C. for one hour. The mass of the film reduced during the heating was regarded as the water content of the film. In this manner, the water content based on 100 parts by mass of polyvinyl alcohol was calculated.

### (Production of Package)

A pouch in a size of 5 cm×4 cm was produced from the resulting water-soluble film for packaging chemicals, and 20 g of a chemical “sodium trichloroisocyanurate (TCCA)” was contained in the pouch. Then, the pouch was wrapped in a polyethylene-laminated aluminum film and heat-sealed, so that the chemical was double sealed. The resulting pouch was left in an oven at 100° C. for 48 hours, thereby producing a package containing a chemical.

### Examples 2 to 4, Comparative Examples 1 to 5

Water-soluble films for packaging chemicals and packages were prepared in the same manner as in Example 1, except that the kinds and amounts of the PVA and the plasticizer, and storage conditions employed in (Production of water-soluble film for packaging chemicals) were changed as shown in Table 2.

### Examples 5 to 7

Packages were produced in the same manner as in Example 1, except that the water-soluble film for packaging chemicals produced in Example 1 was used and that the chemicals shown in Table 2 were used instead of sodium trichloroisocyanurate (TCCA) in (Production of package). In Table 2, DCCA refers to dichloroisocyanuric acid, DBMPA refers to 2,2-dibromo-3-nitrilopropionamide, and BCDMH refers to 1-bromo-3-chloro-5,5-dimethylhydantoin.

### (Evaluation)

The water-soluble films for packaging chemicals and the packages obtained in the examples and the comparative examples were evaluated as follows. Table 2 shows the results.

### (1) Film Evaluation

### (1-1) Orientation

The obtained water-soluble film for packaging chemicals was measured with a phase difference measuring apparatus (KOBRA-WR, produced by Oji Scientific Instruments) at an incident angle of 45°, and the value of the measured phase difference R was taken as the value of the orientation.

### (1-2) Measurement of Thickness

The water-soluble film for packaging chemicals was measured for the thickness with a thickness meter (produced by Mitsutoyo Corporation, ID-C112AE) at five arbitrary points, and the average of the measured values was taken as the thickness of the water-soluble film for packaging chemicals.

### (2) Package Evaluation

(2-1) Water Solubility after Durability Test

The obtained package cut to a size of 35 mm×40 mm was weighed and fixed on a jig. Water (500 ml) charged into a 500-ml beaker was stirred (in such a manner that the lowest portion of the vortex reached the 400 ml mark) with a stirrer and the water temperature was maintained at 23° C. The film fixed on a jig was immersed in that water. The film in the water was left to stand for 60 minutes. The resulting aqueous solution was passed through a mesh filter with an aperture of 300 μm, whose weight was preliminary measured, to separate undissolved gel components. The mesh filter was dried at 80° C. for three hours, and the mass change was measured. The solubility was calculated from the mass change, and the water solubility after durability test was evaluated in accordance with the following criteria.

Good (◯): Solubility of 90% by mass or higher
Poor (x): Solubility of lower than 90% by mass

(2-2) Discoloration Resistance after Durability Test

The obtained package was measured for YI (D1925(2/C) with a ColorQuest XE produced by HunterLab, and the discoloration resistance after durability test was evaluated based on the YI value in accordance with the following criteria.

Good (◯): YI value of 10 or less
Poor (x): YI value of more than 10

### (2-3) Packaging Performance

The obtained package with its surface held horizontally was naturally dropped from the height of 1.5 m to a concrete board having a thickness of 1 cm and a size of 50 cm×50 cm, and the presence of tear in the pouch was checked. The above test was carried out 10 times under the same conditions, and the number of pouches in which damage, tear, or peeling of the heat-sealed portion was found (i.e., the number of defective packages) was counted. The packaging performance was evaluated based on the following criteria.

Good (◯): No defective packages
Poor (x): One or more defective packages

TABLE 2

| | | | Example 1 | Example 2 | Example 3 | Example 4 | Example 5 | Example 6 | Example 7 |
|---|---|---|---|---|---|---|---|---|---|
| Film | Kind of PVA resin | Modified polyvinyl alcohol A | 100 | — | — | 100 | 100 | 100 | 100 |
| composition | | Modified polyvinyl alcohol B | — | 100 | — | — | — | — | — |
| (parts by | | Modified polyvinyl alcohol C | — | — | 100 | — | — | — | — |
| mass) | | Polyvinyl alcohol D | — | — | — | — | — | — | — |
| | Plasticizer | Trimethylolpropane | 3 | 4 | 3 | — | 3 | 3 | 3 |
| | | Glycerin | 3 | 4 | 3 | — | 3 | 3 | 3 |
| | | Polyethyleneglycol 500 | 3 | 4 | 3 | 1 | 3 | 3 | 3 |
| | Water | Water content | 9.1 | 10.6 | 4.6 | 12.8 | 9.1 | 9.1 | 9.1 |

| | | | | | | | | |
|---|---|---|---|---|---|---|---|---|
| Package | Kind of chemicals used | TCCA | TCCA | TCCA | TCCA | DCCA | DBNPA | BCDMH |
| Storage | Storage temperature (° C.) | 23 | 23 | 40 | 80 | 23 | 23 | 23 |
| condition | Storage humidity(% RH) | 50 | 50 | 10 | 80 | 50 | 50 | 50 |
| | Storage time (hours) | 48 | 48 | 48 | 2 | 48 | 48 | 48 |
| Film | Stretching ratio (%) | 50 | 50 | 100 | 150 | 50 | 50 | 50 |
| evaluation | Orientation (nm) | 32 | 28 | 65 | 145 | 32 | 32 | 32 |
| | Thickness (μm) | 52 | 51 | 49 | 50 | 52 | 52 | 52 |
| Package | Water solubility after durability test | ◯ | ◯ | ◯ | ◯ | ◯ | ◯ | ◯ |
| evaluation | Discoloration resistance after durability test | ◯ | ◯ | ◯ | ◯ | ◯ | ◯ | ◯ |
| | Packaging performance | ◯ | ◯ | ◯ | ◯ | ◯ | ◯ | ◯ |

| | | | Comparative | Comparative | Comparative | Comparative | Comparative |
|---|---|---|---|---|---|---|---|
| | | | Example 1 | Example 2 | Example 3 | Example 4 | Example 5 |
| Film | Kind of PVA resin | Modified polyvinyl alcohol A | — | 100 | — | 100 | 100 |
| composition | | Modified polyvinyl alcohol B | — | — | — | — | — |
| (parts by | | Modified polyvinyl alcohol C | 100 | — | — | — | — |
| mass) | | Polyvinyl alcohol D | — | — | 100 | — | — |
| | Plasticizer | Trimethylolpropane | 4 | 3 | 4 | 3 | 3 |
| | | Glycerin | 4 | 3 | 4 | 3 | 3 |
| | | Polyethyleneglycol 500 | 4 | 3 | 4 | 3 | 3 |
| | Water | Water content | 16.1 | 1.5 | 13.8 | 20.2 | 9.1 |

| | | | | | | |
|---|---|---|---|---|---|---|
| Package | Kind of chemicals used | TCCA | TCCA | TCCA | TCCA | TCCA |
| Storage | Storage temperature (° C.) | 60 | 80 | 60 | 80 | 23 |
| condition | Storage humidity(% RH) | 70 | 0 | 70 | 80 | 50 |
| | Storage time (hours) | 3 | 2 | 1 | 3 | 48 |
| Film | Stretching ratio (%) | 0 | 50 | 0 | 50 | 300 |
| evaluation | Orientation (nm) | 1.4 | 40 | 1.3 | 32 | 350 |
| | Thickness (μm) | 53 | 48 | 49 | 50 | 52 |
| Package | Water solubility after durability test | X | ◯ | X | X | ◯ |
| evaluation | Discoloration resistance after durability test | X | ◯ | X | X | ◯ |
| | Packaging performance | ◯ | X | ◯ | ◯ | X |

### INDUSTRIAL APPLICABILITY

The present invention can provide a water-soluble film for packaging chemicals which achieves excellent chemical resistance and water solubility and maintains high packaging properties even in a case of containing highly active chemicals such as agrochemicals or oxidants for a long period of time, and a water-soluble film package including the water-soluble film for packaging chemicals.

1. A water-soluble film for packaging chemicals, comprising polyvinyl alcohol,
the polyvinyl alcohol containing a modified polyvinyl alcohol,
the water-soluble film for packaging chemicals having a water content of 4 to 13 parts by mass based on 100 parts by mass of the polyvinyl alcohol,
the water-soluble film for packaging chemicals having an orientation of 10 to 150 nm.

2. The water-soluble film for packaging chemicals according to claim 1,
wherein the modified polyvinyl alcohol is polyvinyl alcohol modified with at least one hydrophilic group that is selected from the group consisting of a sulfonic acid group, a pyrrolidone ring, an amino group, and a carboxyl group.

3. The water-soluble film for packaging chemicals according to claim 2,
wherein the modified polyvinyl alcohol includes 0.1 to 15 mol % of a constitutional unit having a hydrophilic group.

4. The water-soluble film for packaging chemicals according to claim 1,
wherein the polyvinyl alcohol has a degree of saponification of 80 to 99.9 mol % and, a viscosity of a 4% by mass aqueous solution measured at 20° C. of 4 to 17 mPa·s.

5. The water-soluble film for packaging chemicals according to claim 1, further comprising a plasticizer.

6. The water-soluble film for packaging chemicals according to claim 5,
wherein the plasticizer contains at least one compound selected from the group consisting of glycerin, trimethylolpropane, and polyethylene glycol.

7. The water-soluble film for packaging chemicals according to claim 5,
wherein the amount of the plasticizer is 1 to 12 parts by mass based on 100 parts by mass of the polyvinyl alcohol.

8. A water-soluble film package comprising
the water-soluble film for packaging chemicals according to claim 1, and
a chemical packaged in the water-soluble film.

9. The water-soluble film package according to claim 8,
wherein the chemical is a compound containing chlorine or bromine.

10. The water-soluble film package according to claim 9,
wherein the compound containing chlorine is trichloroisocyanuric acid or dichloroisocyanuric acid.

11. The water-soluble film package according to claim 9,
wherein the compound containing bromine is 2,2-dibromo-3-nitrilopropionamide or 1-bromo-3-chloro-5,5-dimethylhydantoin.
